(19) United States
(12) Patent Application Publication
(10) Pub. No.: US 2025/0061310 A1
(43) Pub. Date: Feb. 20, 2025

(54) METHODS AND SYSTEMS FOR EXECUTING A NEURAL NETWORK WITH BIT ADDITION-BASED INNER PRODUCT OPERATOR

(71) Applicants: Xinlin LI, Montreal (CA); Vanessa COURVILLE, Montreal (CA); Vahid PARTOVI NIA, Brossard (CA); Boxing CHEN, Ottawa (CA)

(72) Inventors: Xinlin LI, Montreal (CA); Vanessa COURVILLE, Montreal (CA); Vahid PARTOVI NIA, Brossard (CA); Boxing CHEN, Ottawa (CA)

(21) Appl. No.: 18/450,142

(22) Filed: Aug. 15, 2023

(51) Int. Cl. G06N 3/0464

(52) U.S. Cl. CPC G06N 3/0464

(57) ABSTRACT

Systems and methods for computing a neural network layer of a neural network are described. A float shift inner product operator is described for computing an inner product between a floating point input vector and a weight vector having weight values that are power of two values. An inner product is computed by performing addition on the sign bits and exponent bits of a floating point input element and corresponding weight element.

### FIELD

The present disclosure is related to methods and devices for executing a neural network with bit addition-based inner product operators, in particular methods and devices using bit addition to compute the inner product for at least one neural network layer having floating point input elements.

### BACKGROUND

A neural network is a computational system comprising computational units (sometimes referred to as neurons) that are arranged in layers (or computational blocks). A neural network includes a first neural network layer (which may be referred to as an input layer), at least one intermediate neural network layer (which may be referred to as intermediate layer(s)) and a final neural network layer (which may be referred to as an output layer). Each neural network layer receives input data (e.g., in the form of an input vector) and performs computations, including applying some weights (e.g., in the form of a weight vector) to the input data to generate output data (e.g., in the form of an output vector). If a neural network has multiple intermediate layers, the output generated by one intermediate layer (which may be referred to as intermediate data) may be used as the input data to a subsequent intermediate layer. The output of a multi-layer neural network is the output generated by the final layer.

When a neural network is executed (e.g., during training or inference), the output of each neural network layer is computed in sequence. Often, computing a neural network layer involves computing an inner product between the input data and the weights of the neural network layer. With increasing neural network complexity (e.g., increasing number of layers), there is an increase in computation cost and memory cost, which may limit the accessibility and/or commercial practicality of more complex neural network architectures.

Accordingly, there is a need for techniques that can perform the computations of a neural network layer with greater efficiency.

### SUMMARY

In various examples, the present disclosure describes techniques, referred to herein as a float shift inner product operator (or simply float shift operator) and a float dense shift inner product operator (or simply float dense shift operator), which may replace the inner product operator that is conventionally used to compute the output of a neural network layer, such as a self-attention neural network layer, a convolutional neural network layer or a fully connected neural network layer of a neural network. The float shift inner product operator or float dense shift inner product operator may be used to compute a neural network layer where the input vector contains floating point input values.

The present disclosure also describes example neural networks that include at least one neural network layer whose output is computed using the float shift inner product operator or float dense shift inner product operator instead of the conventional inner product operator.

In some example aspects, the present disclosure describes a computing system for computing an output of a neural network layer of a neural network. The computing system includes: a memory storing a weight vector for the neural network layer, each element of the weight vector being a weight element encoded as a bit string including a sign bit representing a sign value of the weight element and a set of exponent bits representing an exponent of a weight value; and a processing unit coupled to the memory. The processing unit includes: circuitry configured to receive a floating point input vector to the neural network layer and the weight vector for the neural network layer, each element of the floating point input vector being a floating point input element encoded as a floating point bit string including a sign bit representing a sign value of the input element and a set of exponent bits representing an exponent of the floating point input element; circuitry configured to compute an inner product between the floating point input vector and the weight vector by: for each floating point input element in the floating point input vector and a corresponding weight element in the weight vector, performing addition to add the sign bit of the weight element to the sign bit of the floating point input element and to add the set of exponent bits of the weight element to the set of exponent bits of the floating point input element, to generate a respective weighted input element; and performing floating point summation of the respective weighted input elements to generate the inner product; and circuitry configured to output the inner product as an output element of an output vector of the neural network layer.

In an example of the preceding example aspect of the computing system, each weight element may be encoded as a shift bit value including the sign value of the weight element and the weight value that is a power of two value or zero.

In an example of a preceding example aspect of the computing system, each weight element may be encoded as a dense shift bit value including the sign value of the weight element and the weight value that is a non-zero power of two value.

In an example of any of the preceding example aspects of the computing system, the weight vector may be stored as a low-bit encoded weight vector having low-bit encoded weight elements, each low-bit encoded weight element representing a corresponding weight element using fewer bits, and the low-bit encoded weight vector may be converted to the weight vector.

In an example of some of the preceding example aspects of the computing system, each weight element may have a bit-length equal to a bit-length of the corresponding floating point input element.

In an example of some of the preceding example aspects of the computing system, each weight element may have a bit-length equal to a bit-length of the sign bit plus the set of exponent bits of the corresponding floating point input element.

In an example of some of the preceding example aspects of the computing system, the circuitry configured to compute the inner product between the floating point input vector and the weight vector may include circuitry for an integer addition operator for performing the addition.

In an example of some of the preceding example aspects of the computing system, the circuitry configured to compute the inner product between the floating point input vector and the weight vector may include circuitry for a binary addition operator for performing the addition.

In an example of some of the preceding example aspects of the computing system, the neural network layer may be a fully connected neural network layer, and the weight vector may represent a multi-dimensional weight tensor.

In an example of some of the preceding example aspects of the computing system, the neural network layer may be a self-attention neural network layer, and the weight vector may represent a weights of at least one of a query, key or value matrix.

In an example of some of the preceding example aspects of the computing system, the neural network layer may be a convolutional neural network layer, and the weight vector may represent a convolutional kernel.

In an example of some of the preceding example aspects of the computing system, the processing unit may be a dedicated neural network accelerator.

In an example of some of the preceding example aspects of the computing system, the processing unit may be a general processing unit.

In an example of any of the preceding example aspects of the computing system, the processing unit may further include: circuitry configured to convert each weight element of the weight vector by rounding the weight value of each weight element to a power of two value; where the weight vector of converted weight elements may be used to compute the inner product.

In some examples, the present disclosure describes a method for computing an output of a neural network layer of a neural network. The method includes: receiving a floating point input vector, each element of the floating point input vector being a floating point input element encoded as a floating point bit string including a sign bit representing a sign value of the floating point input element and a set of exponent bits representing an exponent of the input element; obtaining a weight vector for the neural network layer, each element of the weight vector being a weight element encoded as a bit string including a sign bit representing a sign value of the weight element and a set of exponent bits representing an exponent of a weight value; computing an inner product between the floating point input vector and the weight vector by: for each floating point input element in the floating point input vector and a corresponding weight element in the weight vector, performing addition to add the sign bit of the weight element to the sign bit of the floating point input element and to add the set of exponent bits of the weight element to the set of exponent bits of the floating point input element, to generate a respective weighted input element; and performing floating point summation of the respective weighted input elements to generate the inner product; and outputting the inner product as an output element of an output vector of the neural network layer.

In an example of the preceding example aspect of the method, each weight element may be encoded as a shift bit value including the sign value of the weight element and the weight value that is a power of two value or zero.

In an example of a preceding example aspect of the method, each weight element may be encoded as a dense shift bit value including the sign value of the weight element and the weight value that is a non-zero power of two value.

In an example of any of the preceding example aspects of the method, obtaining the weight vector may include converting a low-bit encoded weight vector having low-bit encoded weight elements, each low-bit encoded weight element representing a corresponding weight element using fewer bits, to the weight vector.

In an example of some of the preceding example aspects of the method, each weight element may have a bit-length equal to a bit-length of the corresponding floating point input element.

In an example of some of the preceding example aspects of the method, each weight element may have a bit-length equal to a bit-length of the sign bit plus the set of exponent bits of the corresponding floating point input element.

In an example of some of the preceding example aspects of the method, performing the addition may include performing an integer addition operation.

In an example of some of the preceding example aspects of the method, performing the addition may include performing a binary addition operation.

In an example of any of the preceding example aspects of the method, prior to computing the inner product, each weight element of the weight vector may be converted by rounding the weight value of each weight element to a power of two value, and the weight vector of converted weight elements may be used to compute the inner product.

In some examples, the present disclosure describes a non-transitory computer readable medium having machine-executable instructions stored thereon, wherein the instructions, when executed by an electronic device, cause the electronic device to perform any preceding examples of the preceding example aspects of the method.

In some examples, the present disclosure describes a system chip including a processing unit configured in accordance with any of the examples of the preceding example aspects of the computing system.

In another example aspect, the present disclosure describes a computer program characterized in that, when the computer program is run on a computer, the computer is caused to execute any preceding examples of the preceding example aspects of the method.

### BRIEF DESCRIPTION OF THE DRAWINGS

Reference will now be made, by way of example, to the accompanying drawings which show example embodiments of the present application, and in which:

FIG. 1 is a computation graph illustrating example computations for computing a conventional inner product operator;

FIGS. 2A and 2B illustrate examples of left shift and right shift operations on a bit string;

FIG. 3A illustrates an example bit string representing a floating point value, in accordance with examples of the present disclosure;

FIG. 3B illustrates an example of performing addition on a bit string representing a floating point value, in accordance with examples of the present disclosure;

FIG. 4 is a computation graph illustrating example computations for computing an inner product using a float shift inner product operator, in accordance with examples of the present disclosure;

FIGS. 5A and 5B illustrate two example implementations of the float shift inner product operator, in accordance with examples of the present disclosure;

FIG. 6 is a block diagram illustrating an example computing system, including a processing unit that may be used to implement examples of the present disclosure; and

FIG. 7 is a flowchart illustrating an example method for computing a neural network layer using a float shift inner product operator, in accordance with examples of the present disclosure.

Similar reference numerals may have been used in different figures to denote similar components.

### DETAILED DESCRIPTION

The present disclosure describes techniques, referred to as a float shift inner product operator (IPO) (or simply float shift operator) and a float dense shift IPO (or simply float dense shift operator), which may be used to replace the inner product operator that is conventionally used to compute the output of a neural network layer. For example, the float shift IPO or float dense shift IPO may be used to compute the output of a convolutional neural network layer or the output of a fully connected neural network layer, instead of using the conventional IPO. To assist in understanding the present disclosure, the conventional IPO is first discussed in the context of computing the output of a neural network layer, such as a convolutional neural network layer or a fully connected neural network layer. It should be understood that the present disclosure is not limited to convolutional neural network layers or fully connected neural network layers.

A convolutional neural network layer (also referred to as a convolution layer or CNN layer) generates an output that is based on a convolution of one or more convolutional kernels, each composed of a set of weights (e.g., represented by a weight vector, denoted as W), across the input data (e.g., represented by an input vector) to the convolution layer. In a convolution operation, a kernel is applied to a region of the input vector to calculate an output vector element as the inner product of the kernel weights and the input vector region weights. The kernel is then applied to additional regions of the input vector to generate additional output vector elements for one channel of the output vector. Additional kernels may be convolved with the input vector to generate additional channels of the output vector. In some examples described herein, the input vector region may be denoted X and the kernel (or weight vector) may be denoted W.

A fully connected neural network layer (also referred to as a fully connected layer or FC layer) generates an output that is based on an inner product of one or more dimensions of a multi-dimensional weight vector and the input vector. Additional dimensions of the multi-dimensional weight vector may be applied to the input vector to generate additional elements of the output vector. In some examples described herein, the input vector of a FC layer may be denoted X and the corresponding dimension of the weight vector may be denoted W.

An inner product operator computes the inner product between the vectors X and W, where X and W each have a length of n, to obtain the output (e.g., represented as an output vector, denoted as Y). Computation using the conventional IPO may be expressed as follows:

$$Y = {\sum }_{i = 0}^{n} {X}_{i} \times {W}_{i}$$

where Y is the inner product of vectors X and W; and where Xᵢ and Wᵢ are the i-th element of the vectors X and W, respectively.

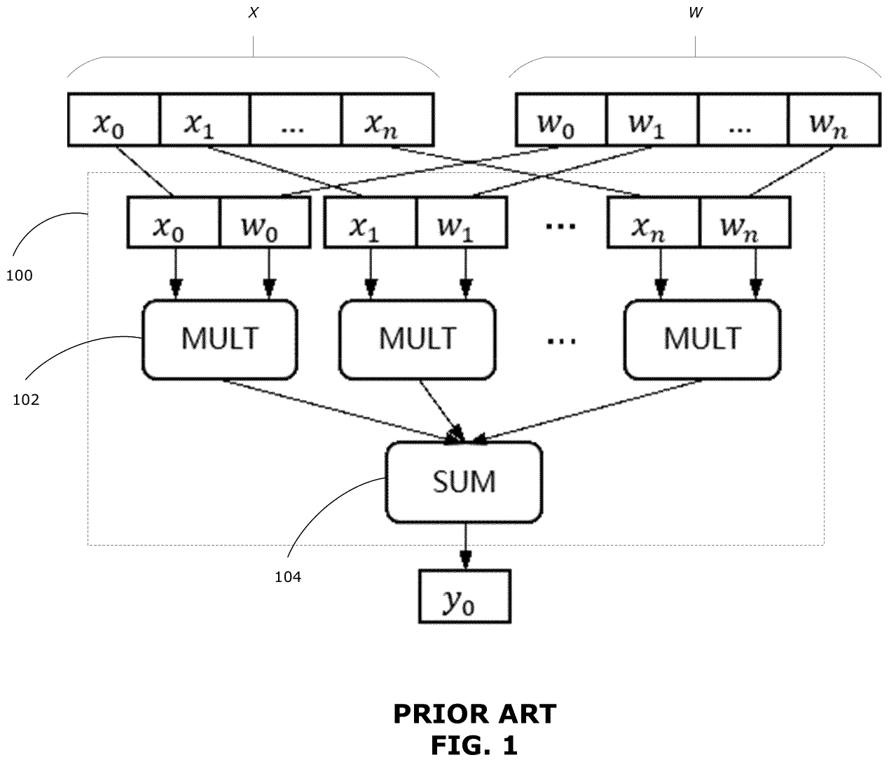

FIG. 1 is a computation graph illustrating the computations required to compute a single element y₀ of the output vector Y, using the conventional IPO 100. The conventional IPO 100 includes multiplication operators 102 and a summation operator 104. The input vector X contains the elements x₀, x₁, . . . , xₙ, and the weight vector W contains the elements w₀, w₁, . . . , wₙ. Element-wise multiplication is performed by taking corresponding elements from the vectors X and W as inputs to the multiplication operators 102. The number of multiplication operators 102 required is equal to the length, n, of the vectors X and W. The outputs of the multiplication operators 102 are provided as input to the summation operator 104. The output of the summation operator 104 is the element y₀ of the output vector Y. It should be understood that each of the operators 102, 104 is implemented in hardware using circuitry that includes a set of logic gates that are in turn implemented using transistors.

The number of multiplication operators required to compute the conventional IPO increases with the size of the input data (i.e. the number of elements in the input vector X). In the case where the conventional IPO is used to compute the output of a convolutional neural network layer, the number of multiplication operators required increases with the size of the input data, the size of the convolutional kernel (i.e. the number of elements in the weight vector W), and the number of output channels of the convolutional neural network layer. For example, for a 2D convolutional neural network layer (e.g., commonly used for processing 2D images), the output of the convolutional neural network layer may be expressed as follows:

$$Y = Conv 2 D ( X , W )$$

$${Y}_{h , w , {c}_{out}} = {\sum }_{{c}_{i n}}^{{N}_{i n}} {\sum }_{i = 0}^{k} {\sum }_{j = 0}^{k} {X}_{h + i , w + j , {c}_{i n}} \times {W}_{i , j , {c}_{i n} , {c}_{out}}$$

where cᵢₙ and cₒᵤₜ are the input and output channels, respectively; where X is a 2D patch of the input image, and where W is a 2D convolutional kernel. The input and output channels may each include a channel for a height of the input image, a channel for a width of the input image, and a channel for each feature of the input image. For a large input image, the inner product must be computed between the 2D convolutional kernel and many 2D patches of the input image (which may be referred to as “2D image patches”). It can be appreciated that, when the computations of a convolutional neural network layer is performed using the conventional IPO, a large number of multiplication operators are required to compute the output Y, particularly when the input image is large.

Computation of fully connected neural network layer also involves a large number of multiplication operations. The weight vector includes a number of weights equal to the number of input vector elements multiplied by the number of output vector elements. Thus, a fully connected layer with an input vector X of size N elements, configured to generate an output vector Y of M elements, requires a weight vector W of (M×N) weights, and generating the output vector Y based on the input vector X requires (M²×N) multiplication operations. These multiplication operations may incur significant computational costs, particularly in deep neural networks using input and output vectors containing thousands of elements.

The computations required to compute the output of a neural network layer (such as during training of the neural network and/or during use of the neural network for inference) are often performed by a dedicated neural network accelerator. Using the multiplication operator to compute the output of a layer (e.g., convolutional layer or fully connected layer) of a neural network using the conventional IPO results in the neural network being costly to compute, in terms of in computer hardware. By “costly” in computer hardware, it is meant that the multiplication operator requires circuitry that includes a large number of logic gates (and hence a large number of transistors) to implement in a processing unit. The cost of the multiplication operator is also high in terms of financial cost (e.g., high cost of manufacture a hardware device that implements the multiplication operator), energy cost (e.g., high energy consumption) and size cost (e.g., requires large hardware footprint on a hardware device, for example occupying a significant amount of the chip area in a dedicated neural network accelerator). Thus, using the conventional IPO to perform the computations of a neural network layer requires circuitry that takes up a considerable amount of the area in a dedicated neural network accelerator and results in the dedicated neural network accelerator consuming a significant amount of power when performing the computations of a neural network layer.

Quantization is an existing technique that compresses the size of a neural network by reducing the number of bits required to store the weights of the neural network. In this technique, trained weights of the neural network are stored as low-bit fixed point integer values rather than high-precision floating point values that were used during training. Using fixed-point quantization enables high-cost floating point multiplication operators to be replaced with lower-cost (e.g., lower manufacturing cost, lower power consumption, etc.) fixed point multiplication operators.

Further improvements in efficiency can be achieved by techniques that use bit-wise operators to replace some specific fixed point integer multiplication operators. For example, because the sign of an integer is represented using a binary bit, fixed point multiplication of integers with the value −1 may be efficiently implemented using bit-wise negation instead of multiplication. Another efficient technique for fixed point integer multiplication is to use a bit shift operation for multiplication of integers by a value that is a power of two. Specifically, if an integer x is multiplied by a value 2^{p} (where p is any integer), the computation may be carried out as follows:

$$x \times {2}^{p} = \{ \begin{matrix}x ≪ \vert p \vert & p > 0 \\ x ≫ \vert p \vert & p < 0 \\ x & p = 0\end{matrix}$$

where << is a left shift operator, and >> is a right shift operator.

Shifting left by p-bits is equivalent to multiplying by 2^{P}, and shifting right by p-bits is equivalent to multiplying by ½^{P}.

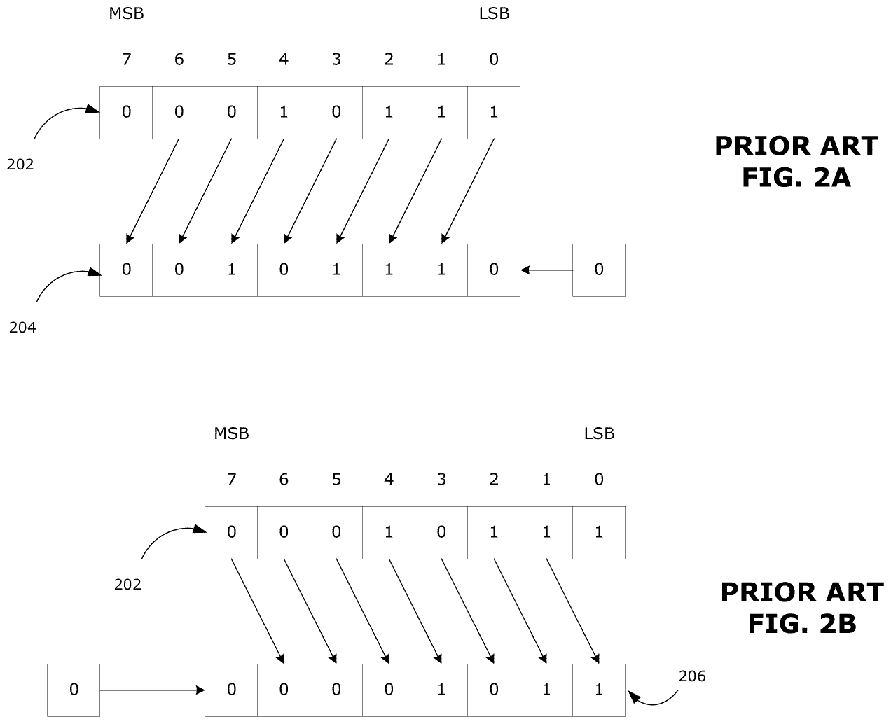

FIGS. 2A and 2B illustrate examples of using bit shifting to perform multiplication of an integer with a power of two value. The integer value 23 is represented as the 8-bit binary string 202 “00010111”, where the most significant bit (MSB) is at the leftmost position and the least significant bit (LSB) is at the rightmost position. FIG. 2A illustrates that multiplying by 2 (i.e., 2¹) is equivalent to left shifting the binary string 202 by 1 bit, to obtain the binary string 204 “00101110”, which represents the integer value 46. FIG. 2B illustrates that multiplying by ½ (i.e., 2⁻¹) is equivalent to right shifting the binary string 202 by 1 bit, to obtain the binary string 206 “00001011”, which represents the integer value 11.

In this way, multiplication of a fixed point integer with a power of two number can be implemented by left or right shifts of the binary representation. It may be recognized that when bit shifting is performed, a binary value of 0 is used to pad the shifted binary string. Further, it may be recognized that fixed point multiplication of integers implicitly rounds down any non-integral values to the next integer. Depending on the fixed point integer representation format, the logical shift or the arithmetic shift may be used. Regardless of whether logical shift or arithmetic shift is used for bit shifting, the bit shift operator requires significantly lower power consumption compared to the multiplication operator when performed in application-specific integrated circuits (ASICs) and field-programmable gate arrays (FPGAs).

Some solutions to improving the efficiency of neural networks have involved replacing the conventional IPO with a fixed point IPO in which quantized input data are multiplied by weights having discrete power of two values.

A drawback of such solutions is that some neural network layers, such as neural network layers implementing softmax, Gaussian error linear unit (GELU) or layer normalization (LayerNorm), do not support computation on fixed point quantized input data and only output floating point data. The result is that quantize and de-quantize operators need to be added to the neural network to convert between quantized data and non-quantized (e.g., floating point) data, between layers of the neural network. These conversions require extra computational resources (e.g., extra processing power, memory resources, power consumption, etc.) and may result in increased latency during execution of the neural network.

Another drawing back of such solutions is that some neural network tasks, such as language tasks performed by large language models (LLMs), have been found to suffer in accuracy when fixed point quantization is used.

The present disclosure describes example methods, systems and devices that may enable more efficient computations in a neural network, while avoiding at least some of the drawbacks associated with quantized fixed point IPO.

In various examples, the present disclosure describes methods and systems for computing the output vector Y of a neural network layer (e.g., a convolutional neural network layer, a fully connected neural network layer, or other neural network layer that conventionally is computed using the inner product operator) using a float dense shift IPO.

To assist in understanding the present disclosure, some terminology is now presented. It should be understood that these terms are not intended to be limiting; other terminology may be used within the scope of the present disclosure.

In general, a shift neural network may refer to a neural network in which at least one neural network layer (which may be referred to as a shift neural network layer) has weight values limited to discrete values of zero or positive/negative power of two numbers (i.e., limited to 0 ∪{±2^{P}}, where p is an integer). An integer shift IPO, also referred to as a shift IPO with fixed point quantized activation (where the term activation may refer to the inputs to the shift neural network layer), is a bit shift-based IPO used for computation of a shift neural network layer having fixed point quantized input (i.e., integer value inputs). A dense shift neural network may refer to a neural network in which at least one neural network layer (which may be referred to as a dense shift neural network) has weight values limited to discrete values of power/negative power of two numbers (i.e., limited to {±2^{P}}, where p is an integer). An integer dense shift IPO, also referred to as a dense shift IPO with fixed point quantized activation (where the term activation may refer to the inputs to the dense shift neural network layer), is a bit shift-based IPO used for computation of a dense shift neural network layer having fixed point quantized input (i.e., integer value inputs).

The present disclosure describes a float shift IPO, which is a bit addition-based IPO used for computation of a shift neural network layer having non-quantized floating point input. The present disclosure also describes a float dense shift IPO, which is a bit addition-based IPO used for computation of a dense shift neural network layer having non-quantized floating point input.

The present disclosure encompasses any neural network that includes at least one neural network layer that is executed using the float shift IPO or float dense shift IPO, as disclosed herein. A neural network that is encompassed by the present disclosure may include at least one neural network layer that is executed using the disclosed float shift IPO or float dense shift IPO, and additionally one other neural network layer that is executed using a conventional IPO or using an integer shift IPO or integer dense shift IPO. That is, embodiments of the present disclosure do not necessarily exclude the use of other existing types of IPO.

To assist in understanding the present disclosure, the definition of floating point number formats is first discussed.

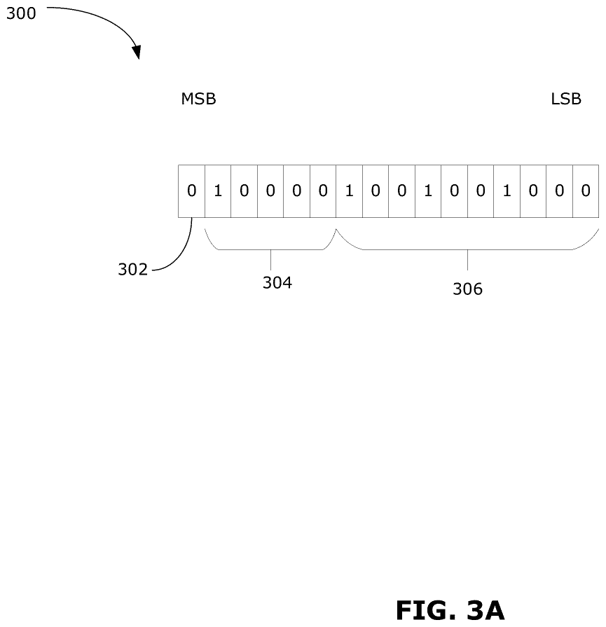

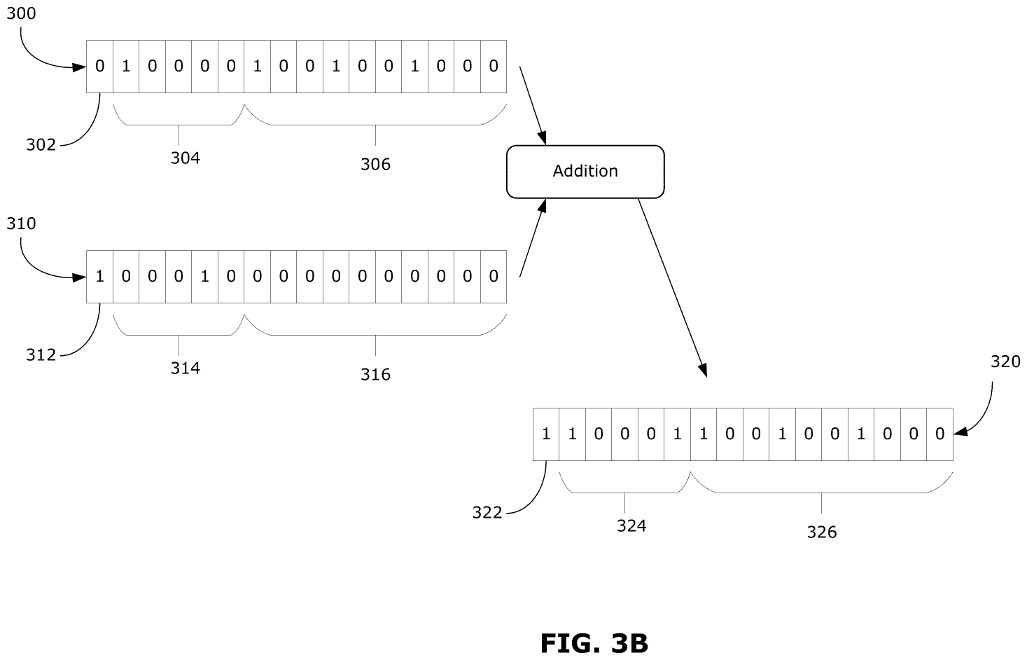

FIG. 3A illustrates an example of how a floating point number may be encoded as a bit string (i.e., as a binary representation), as defined by standards. FIG. 3A illustrates an example using FP16 format, also referred to as half-precision floating point format. FP16 is a binary format that uses 16 bits to store a floating point value, and is suitable for storing values that may be used to compute a neural network layer (e.g., during execution of the neural network for training or inference).

In this example, a bit string 300 encodes the floating point value 3.14 using FP16 format. The bit string 300 includes a sign bit 302, a set of exponent bits 304 and a set of mantissa bits 306.

Although FIG. 3A illustrates an example using FP16 format, it should be understood that this is not intended to be limiting and the present disclosure is not bound to any specific floating point format. In general, it may be sufficient that the floating point number is encoded as a bit string having a sign bit representing a sign value of the floating point number and a set of exponent bits representing an exponent of the floating point number.

Based on this floating point definition, the actual numerical value represented by the bit string 300 may be obtained according to the equation

$$fl ( x ) = {( - 1 )}^{s} \times {2}^{e + {e}_{bias}} \times ( 1 + \frac{m}{{2}^{{m}_{bits} - 1}} )$$

where x is the floating point number, fl(·) is the function for float representation, s is the value of the sign bit 302 (i.e., 1 or 0), e is the unsigned integer value represented by the set of exponent bits 304, m is the unsigned integer value represented by the set of mantissa bits 306, m_{bits} is the bit-width of the set of mantissa bits 306 (i.e., the number of mantissa bits 306) and e_{bias} is the constant exponent bias value defined in the floating point standard. For example, for the 32-bit float format defined in the IEEE 754 standard, m_{bits}=23 and e_{bias}=−127.

The number 3.14 is represented in the bit string 300 as 0100001001001000 according to the FP16 format. The sign bit 302 has a value of 0 to indicate a positive sign, the set of exponent bits is “10000” and the set of mantissa bits is “0010001000”.

Based on the definition of the binary representation for a floating point number, the multiplication of a floating point number with a power of two number is equivalent to performing binary addition on the set of exponent bits of the floating point number. Similarly, multiplication of a floating point number by −1 is equivalent to performing a bit-flip on the sign bit, which can be achieved by adding a binary value of 1 to the sign bit.

FIG. 3B illustrates an example of the above concept. In FIG. 3B, the floating point number 3.14 is multiplied by the power of two number −4 (i.e., multiplied by −2²). The floating point number 3.14 is represented by the bit string 300 as discussed above. The power of two number −4 is represented by another bit string 310 that includes a sign bit 312 representing the sign value of the power of two number (in this example, the sign bit 312 has a value of 1 to indicate negative sign), and a set of exponent bits 314 representing the exponent value of the power of two number (in this example, the exponent value is 2, which is represented by the bits 10). It may be noted that the set of mantissa bits 316 in the bit string 310 is set to all zero.

The product of 3.14 multiplied by −2² is then equivalent to performing binary addition by adding the sign bit 312 of the bit string 310 to the sign bit 302 of the bit string 300, and adding the exponent bits 314 of the bit string 310 to the exponent bits 304 of the bit string 300. It may be noted that the mantissa bits 306 of the bit string 300 are not affected. The result of the binary addition is the bit string 320 1100101001001000, which represents −12.57 in FP16 format and which is the correct product of 3.14 and −2².

As illustrated by the above example, the multiplication of a floating point number with a positive or a negative power of two number can be performed using a single binary addition operation on the sign and exponent bits. Because the mantissa bits are not affected, a low-bit binary addition operation may be used. For example, the multiplication between a FP16 floating point number and a positive or negative power of two integer may be implemented using a 6-bit binary addition operation that operates on the 1-bit sign bit and the 5-bit exponent bits.

The present disclosure thus discloses a float shift IPO that may be used in place of conventional IPO or quantized shift IPO. Also disclosed is a float dense shift IPO that may be used in place of conventional IPO or quantized dense shift IPO. The difference between the float shift IPO and the float dense shift IPO is the type of the power of two values that can be used for weight values-float shift IPO supports positive and negative power of two weight values and also zero; float dense shift IPO support positive and negative power of two weight values excluding zero. Both may be encompassed by the present disclosure. For simplicity, the present disclosure may consider float dense shift IPO to be encompassed by the term float shift IPO. Execution of a neural network using the disclosed float shift IPO to compute at least one neural network layer may enable greater efficiency in execution of the neural network during training and/or inference.

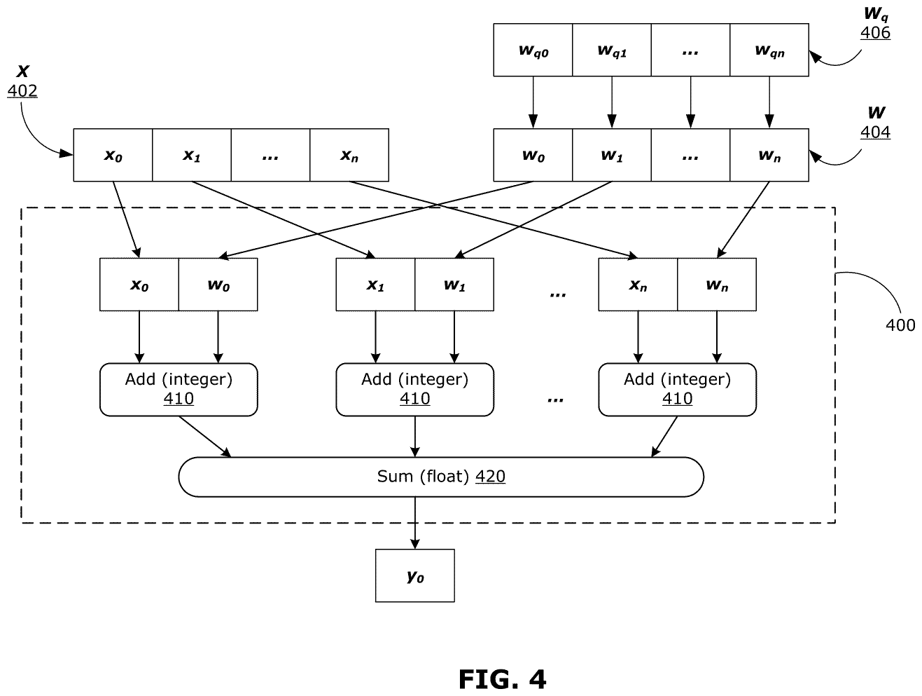

FIG. 4 is a computation graph illustrating the computations used to compute a single output element y₀, which is an element of the output vector of a neural network layer, using the disclosed float shift IPO 400. The input vector X 402 contains the non-quantized (i.e., floating point) input elements x₀, x₁, . . . , xₙ, and the weight vector W 404 contains the weight elements w₀, w₁, . . . , wₙ.

Each input element xᵢ has a corresponding weight element wᵢ. Each weight element wᵢ is encoded as a shift value that is a positive or negative power of two number. In some examples, a zero value may be permitted for a weight element wᵢ (i.e., wᵢ ∈{0, ±2^{P}}); in other examples (such as dense shift), a weight element wᵢ must have a non-zero value (i.e., wᵢ ∈{+2^{P}}).

In some examples, the weight vector W 404 may be converted from a low-bit encoded weight vector W_{q} 406 having low-bit encoded weight elements w_{q0}, w_{q1}, . . . , w_{qn}. The low-bit encoded weight vector W_{q} 406 may enable weight values to be stored more efficiently, and may be easily converted to the weight vector W 404 that is used for computing a neural network layer. For example, if the weight value is −8=−2³, this may be stored as the 3-bit dense shift encoded weight element “111” (it should be noted that this low-bit encoding may be different if shift encoding is used instead of dense shift encoding). Then, when this weight value is used in computing a neural network layer, the 3-bit encoded weight element “111” may be readily converted to the 16-bit computing weight element “1000110000000000” (in the example where FP16 format is used for the floating point input elements).

Computation of the float shift IPO 400 involves using an addition operation 410 to add the sign bit and exponent bits of each input element xᵢ with the sign bit and exponent bits of the corresponding weight element wᵢ, to obtain a respective weighted input element. Then all weighted input elements (i.e., the result of all addition operations 410) are summed in a summation operation 420 to generate an inner product y₀, which is a floating point output element of the output vector generated by computing the neural network layer.

It should be understood that each of the operations 410, 420 may be implemented appropriate operators in hardware, using circuitry that includes a set of logic gates that are in turn implemented using transistors. For example, the addition operations 410 may be implemented using hardware for integer addition or binary addition, and the summation operation 420 may be implemented using hardware for floating point summation.

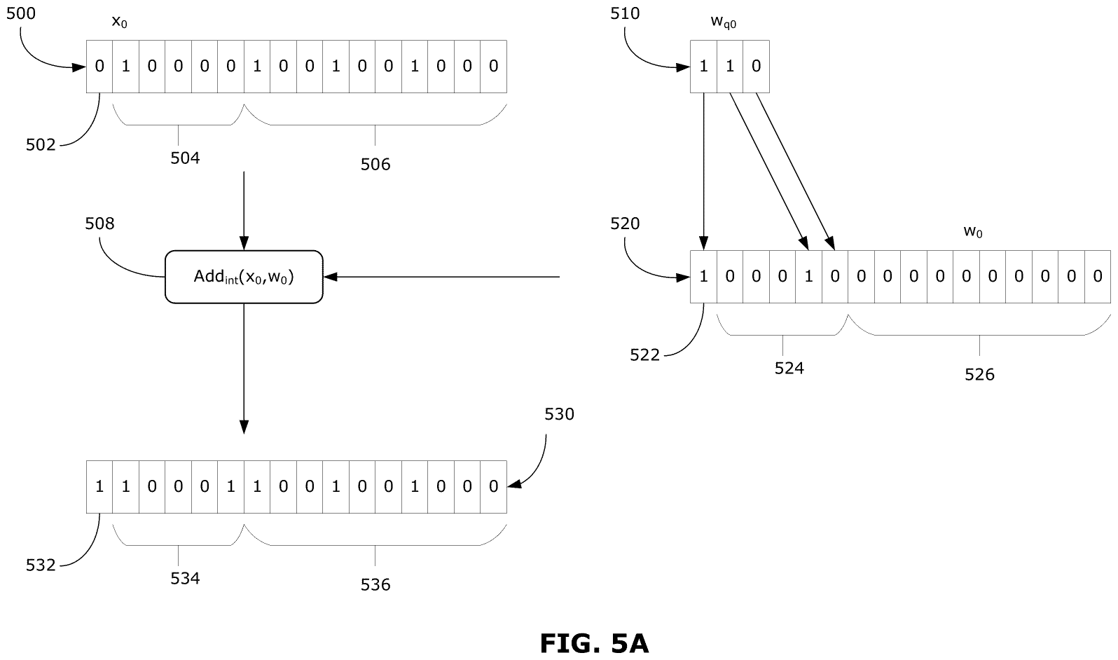

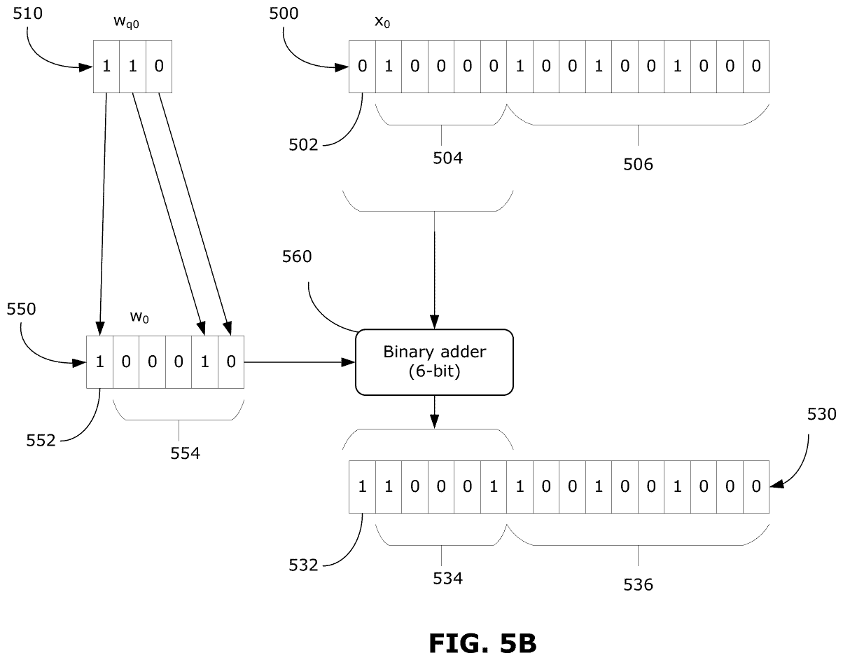

FIGS. 5A and 5B illustrate different examples of how the float shift IPO may be implemented in hardware.

FIG. 5A illustrates the use of an integer addition operator for performing the addition operations 410 of the float shift IPO.

In this example, an input element x₀ having floating point value 3.14 is represented by the bit string 500 “0100001001001000”, which includes a sign bit 502, a set of exponent bits 504 and a set of mantissa bits 506 according to the FP16 format. A low-bit encoded weight element w_{q0} stores the weight value −4 using three bits 510 “110”. This low-bit encoded weight element w_{q0} is converted to the 16-bit computing weight element w₀ that is represented by the bit string 520 “1000100000000000”, including a sign bit 522, a set of exponent bits 524 and a set of mantissa bits 526. The addition operation 410 may then be implemented using an appropriate integer addition operator 508 (e.g., UINT16 for 16-bit integer addition), which may be readily available on conventional hardware such as general central processing units (CPUs) or graphical processing units (GPUs), as well as more specialized ASICs or FPGAs. The result is the weighted input element represented by the bit string 530 “1100101001001000”. It may be noted that the bit string 530 has a sign bit 532 and a set of exponent bits 534 that result from addition of the sign bits 502, 522 to each other and addition of the exponent bits 504, 524 to each other, while the mantissa bits 506 of the bit string 500 representing the input element x₀ are unaffected.

FIG. 5B illustrates the use of a 6-bit binary addition operator for performing the addition operations 410 of the float shift IPO.

In this example, the input element x₀ having floating point value 3.14 is represented by the bit string 500 “0100001001001000”, and the low-bit encoded weight element w_{q0} stores the weight value −4 using three bits 510 “110”, similar to the example of FIG. 5A. The low-bit encoded weight element w_{q0} is converted to a 6-bit computing weight element w₀ that is represented by the bit string 550 “100010”, which includes a sign bit 552 and a set of exponent bits 554. Notably, the bit string 550 representing the computing weight element w₀ does not include any mantissa bits. Since the mantissa bits in a FP16 format representation of the weight element w₀ are all zeros, omitting the mantissa bits enables greater efficiency (e.g., requiring fewer computing and memory resources to be used) without losing any precision. The addition operation 410 may then be implemented using a 6-bit binary addition operator 560, which may be available in specialized hardware such as dedicated ASICs or FPGAs. The result is the weighted input element represented by the bit string 530 “1100101001001000”, which is the same as in the example of FIG. 5A.

Regardless of whether general integer addition operators or specialized binary addition operators are used, the float shift IPO as described above may enable computation of an inner product between a floating point input element and a power of two weight element using relatively efficient operators (e.g., by avoiding the need for computationally expensive floating point multiplication operators), while avoiding quantization of the input element or output element. The disclosed float shift IPO thus enables a neural network layer to be computed, and thus a neural network to be executed, with greater efficiency while avoiding loss of accuracy due to quantization.

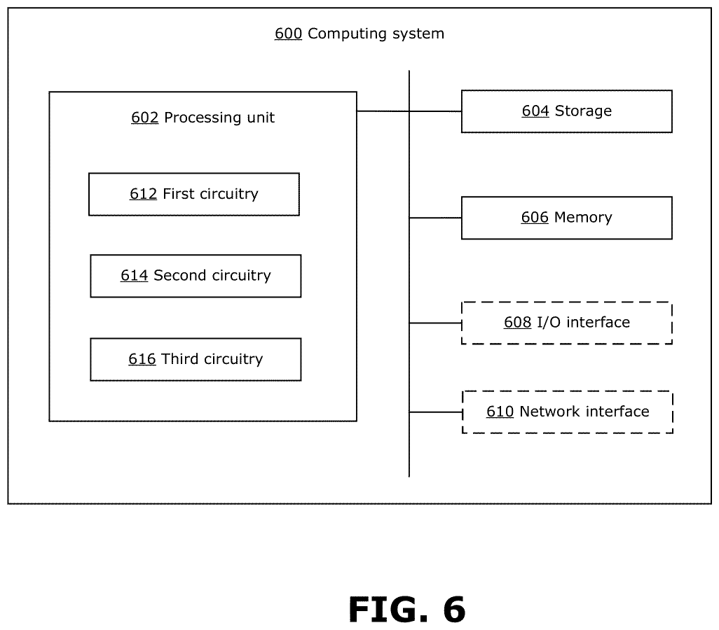

FIG. 6 is a block diagram illustrating an example computing system 600, including a processing unit 602 that may be used to execute a neural network, including computing the output of at least one neural network layer using the disclosed float shift IPO.

The examples disclosed herein may be implemented in other computing systems having different configurations and/or having different components than those shown in FIG. 6. The computing system 600 may be used to execute instructions for training a neural network and/or to execute instructions of a trained neural network to generate inference output. In some examples, the computing system 600 may be used for executing a trained neural network, and training of the neural network may be performed by a different computing system; or the computing system 600 may be used for training the neural network, and execution of the trained neural network may be performed by a different computing system; or the computing system 600 may be used for both training the neural network and for executing the trained neural network.

Although FIG. 6 shows a single instance of each component, there may be multiple instances of each component in the computing system 600. Further, although the computing system 600 is illustrated as a single block, the computing system 600 may be a single physical machine or device (e.g., implemented as a single computing device, such as a single workstation, single consumer device, single server, etc.), or may comprise a plurality of physical machines or devices (e.g., implemented as a server cluster). For example, the computing system 600 may represent a group of servers or cloud computing platform providing a virtualized pool of computing resources (e.g., a virtual machine, a virtual server).

The processing unit 602 may include any suitable general or specialized hardware device, such as a processor, a microprocessor, an ASIC, a FPGA, a dedicated logic circuitry, or combinations thereof. The processing unit 602 may be a CPU, a GPU, a tensor processing unit (TPU), or a neural processing unit (NPU), for example. In some examples, the processing unit 602 includes a host processor and a specialized neural network processor (e.g., a dedicated neural network accelerator or AI accelerator) that is designed for computation of a neural network layer using the disclosed float shift IPO. In other examples, the processing unit 602 may not include a specialized neural network processor and the computation of a neural network layer using the disclosed float shift IPO may be performed using a general CPU or GPU, for example.

The computing system 600 may also include a storage unit 604, which may include a mass storage unit such as a solid state drive, a hard disk drive, a magnetic disk drive and/or an optical disk drive.

The computing system 600 may include a memory 606, which may include a volatile or non-volatile memory (e.g., a flash memory, a random access memory (RAM), and/or a read-only memory (ROM)). The non-transitory memory 606 may store instructions for execution by the processing unit 602, including instructions for computing the output of a neural network layer using the disclosed float shift IPO. The memory 606 may include other software instructions, such as for implementing an operating system and other applications/functions. In some examples, the memory 606 may include software instructions and data (e.g., weight values) to enable the processing unit 602 to compute the output of a neural network layer for example during training or inference. The memory 606 may store weight data (e.g., one or more sets of weights for respective one or more neural network layer), for example in the form of weight vectors (which may be low-bit encoded weight vectors).

Although the memory 606 is illustrated as a single block, it should be understood that the memory 606 may include one or more memory units. For example, the memory 606 may include a cache for temporary storage of instructions. The cache may enable the processing unit 602 to more quickly access instructions during execution, thus speeding up execution of the instructions. In some examples, the processing unit 602 may also include one or more internal memory units, such as an input buffer that stores input data (e.g., input data to be forward propagated through one or more neural network layers), a weight buffer that stores weight data (e.g., one or more sets of weights for respective one or more neural network layers), and an output buffer that stores output data (e.g., output data computed from one or more neural network layers). Internal memory of the processing unit 602 may be used for temporary storage of data during execution of a neural network (e.g., during training and/or inference), and may be cleared after execution is complete.

In some examples, one or more data sets and/or modules may be provided by an external memory (e.g., an external drive in wired or wireless communication with the computing system 600) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The computing system 600 may also include an optional input/output (I/O) interface 608, which may enable interfacing with other devices. The computing system 600 may include an optional network interface 610 for wired or wireless communication with a network (e.g., an intranet, the Internet, a P2P network, a WAN and/or a LAN) and/or another computing device. In some examples, the computing system 600 may communicate with a cloud computing platform via the optional network interface 610, for example to access cloud-based resources (e.g., a cloud-based service for training a neural network).

The processing unit 602 includes circuitry for computing a neural network layer using the disclosed float shift IPO. The circuitry of the processing unit 602 may include a first circuitry 612 to receive a floating point input vector and a weight vector for the neural network layer (which may be retrieved from the memory 606), a second circuitry 614 to compute the float shift IPO between the floating point input vector and the weight vector (e.g., including hardware such as transistors for implementing integer addition or binary addition, with floating point summation as described above), and a third circuitry 616 to output the inner product as an output element of the output vector.

The computing system 600 may be used to compute the output of a neural network (e.g., during training and/or during inference). In particular, the computing system 600 may be used to compute the output of a neural network including computing at least one neural network layer using the float shift IPO (which may be referred to as a float shift neural network layer). For example, instructions encoding the architecture of the neural network may be stored in the memory 606 (or the storage 604), and weights of the neural network layers may be stored as data in the memory 606 (or the storage 604). To compute a float shift neural network layer, a weight vector for the float shift neural network layer (e.g., retrieved from a cache or weight buffer) and a floating point input vector to the float shift neural network layer (e.g., retrieved from an cache or input buffer) are received by the processing unit 602. The floating point input vector may be a subset of the floating point input data to the float shift neural network layer. For example, the input data to the float shift neural network layer may represent an input image, or a multi-dimensional matrix of floating point activation values (e.g., from a preceding neural network layer of the neural network). The processing unit 602 computes a floating point output element, using the disclosed float shift IPO. The output element may be stored in a cache or output buffer. An output vector may be computed for the float shift neural network layer by computing each output element as described above and accumulating the output elements (e.g., in a cache or output buffer) until the entire output vector has been computed. The computed output vector may be used as input to compute a following layer of the neural network, or may be outputted as the final output of the neural network (e.g., if the float shift neural network layer is the final layer of the neural network).

Different neural network layers, such as but not limited to fully connected layers, convolution layers and/or attention layers, may be designed to be computed using the float shift IPO as disclosed herein.

For example, a fully connected layer may be designed based on the float shift IPO with 3-bits dense shift. For a conventional fully connected layer that is computed using the conventional IPO, the j-th output element yⱼ may be represented by the following formula:

$${y}_{j} = {\sum }_{i = 0}^{n} {W}_{i , j} {x}_{i}$$

$${W}_{i , j} ∈ ℝ , {x}_{i} ∈ ℝ , 0 \leq j < m$$

where xᵢ denotes the i-th input element and W_{i,j} denotes the i,j-th weight element of the weight tensor W. The conventional fully connected layer may be replaced with a fully connected float shift neural network layer, i.e., a fully connected layer that is designed to be computed using the disclosed float shift IPO. Specifically, this may be done by replacing the weight tensor values of the fully connected layer with weight tensor values that are limited to the power of two range supported by the float shift IPO (i.e., a positive or negative power of two number or zero, or a positive or negative power of two number excluding zero if using dense shift). For example, if the float shift IPO supports 3-bit dense shift, then the weight value should be limited to the range {±1, ±2, ±4, ±8}. Limiting the weight tensor values to the supported range may be done by, for example, rounding the weight tensor values of the conventional fully connected layer to the nearest value in the range {±1, ±2, ±4, ±8}. In another example, limiting the weight tensor values to the supported range may be done by retraining the neural network using existing quantization-aware training (QAT) techniques. In yet another example, a suitable technique for training a neural network to use power of two weight values is described in PCT application no. PCT/CN2022/077842, entitled “METHODS, SYSTEMS, AND MEDIA FOR LOW-BIT NEURAL NETWORKS USING BIT SHIFT OPERATIONS”, the entirety of which is hereby incorporated by reference.

In another example, the disclosed float shift IPO may be used for computing a self-attention layer, i.e., a self-attention neural network layer that is designed to be computed using the disclosed float shift IPO. Generally, a self-attention layer and its variants may be used in deep learning neural network models for performing sequence to sequence tasks, such as machine translation tasks and question answering tasks. Generally, in a self-attention layer, query, key and value matrices (denoted Q, K and V, respectively) are computed based on the input matrix X (containing floating point input elements) and their corresponding weight matrices W_{Q}, W_{K} and W_{V} (each containing weight elements). Computation of the self-attention layer may be represented by the following equations:

$$Q = {XW}_{Q}$$

$$K = {XW}_{K}$$

$$V = {XW}_{V}$$

$${W}_{Q} ∈ {ℝ}^{{d}_{model} \times {d}_{Q}} , {W}_{K} ∈ {ℝ}^{{d}_{model} \times {d}_{K}} , {W}_{V} ∈ {ℝ}^{{d}_{model} \times {d}_{V}} , X ∈ {ℝ}^{{len}_{seq} \times {d}_{model}}$$

The conventional self-attention layer may be replaced with a self-attention float shift neural network layer, i.e., a self-attention layer that is designed to be computed using the disclosed float shift IPO. Specifically, this may be done by replacing the weight values of one or more of the weight matrices W_{Q}, W_{K} and W_{Y} with weight values that are limited to the power of two range supported by the float shift IPO (i.e., a positive or negative power of two number or zero, or a positive or negative power of two number excluding zero if using dense shift). For example, if the float shift IPO supports 4-bit dense shift, then the weight value should be limited to the range {±1, ±2, ±4, ±8, ±16, ±32, ±64, ±128}. Limiting the weight values to the supported range may be done by, for example, rounding the weight values of the weight matrix W_{Q}, W_{K} and/or W_{Y} to the nearest value in the range {±1, ±2, ±4, ±8, ±16, ±32, ±64, ±128}, or by retraining the neural network using QAT or the training method in PCT application no. PCT/CN2022/077842 incorporated by reference as discussed above.

In another example, the disclosed float shift IPO may be may be used for computing a convolution layer, i.e., a convolution neural network layer that is designed to be computed using the disclosed float shift IPO. The computation of a conventional convolution layer may be represented using the following formula:

$${Y}_{h , w , {c}_{out}} = {\sum }_{{c}_{i n}}^{{N}_{i n}} {\sum }_{i = 0}^{k} {\sum }_{j = 0}^{k} {W}_{i , j , {c}_{i n} , {c}_{out}} {X}_{h + i , w + j , {c}_{i n}}$$

$${W}_{i , j , {c}_{i n} , {c}_{out}} ∈ ℝ , {X}_{h + i , w + j , {c}_{i n}} ∈ ℝ$$

where Y denotes the output of the convolution layer, W denotes the convolution kernel (containing weight elements) and X denotes the input matrix (containing floating point input elements).

The conventional convolution layer may be replaced with a convolution float shift neural network layer, i.e., a convolution layer that is designed to be computed using the disclosed float shift IPO. Specifically, this may be done by replacing the weight values of the convolution kernel W with weight values that are limited to the power of two range supported by the float shift IPO (i.e., a positive or negative power of two number or zero, or a positive or negative power of two number excluding zero if using dense shift). For example, if the float shift IPO supports 2-bit dense shift, then the weight value should be limited to the range {±1, ±2}. Limiting the weight values to the supported range may be done by, for example, rounding the weight values of the convolution kernel W to the nearest value in the range {±1, ±2}, or by retraining the neural network using QAT or the training method in PCT application no. PCT/CN2022/077842 incorporated by reference as discussed above.

In general, it has been found that replacing one or more conventional neural network layers with respective one or more float shift neural network layers by limiting the weight values to power of two values does not significantly decrease the overall performance or accuracy of the neural network that includes the float shift neural network layer(s).

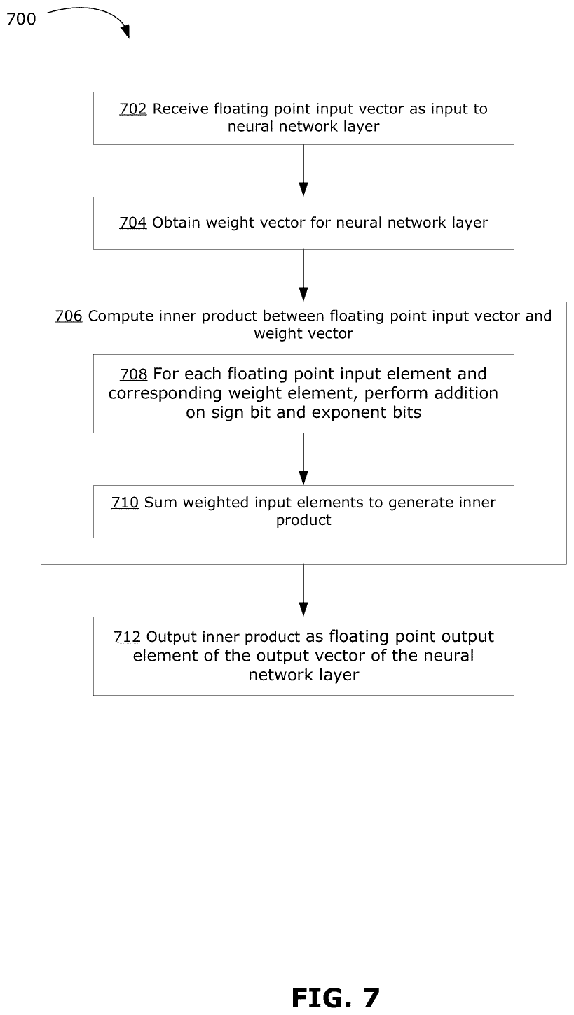

FIG. 7 is a flowchart illustrating an example method 700 for computing a neural network layer using the disclosed float shift IPO. In particular, the method 700 may encompass computing the neural network layer using a float dense shift IPO (in which weight values are restricted to non-zero power of two values) as well as computing the neural network layer using the regular float shift IPO (in which weight values are restricted to power of two values or zero). The method 700 may be performed by any suitable computing system (e.g., the computing system 600), including any computing system that has a general CPU or GPU as the processing unit as well as any computing system that has a specialized neural network accelerator (e.g., ASIC or FPGA) as the processing unit.

The neural network layer that is being computed may, for example, be the fully connected float shift neural network layer, the self-attention float shift neural network layer or the convolution float shift neural network layer as described previously, among other possibilities.

At 702, a floating point input vector is received as input to the neural network layer being computed. Each input element of the floating point input vector is a floating point value that is encoded as a floating point bit string (e.g., as described with respect to FIG. 3A). The floating point bit string includes a sign bit representing a sign value of the input element and a set of exponent bits representing an exponent of the input element. The floating point bit string also includes a set of mantissa bits.

At 704, a weight vector for the neural network layer is obtained (e.g., retrieved from a memory). The weight vector may represent, for example, a weight matrix of the neural network layer. For example, if the neural network layer is a fully connected neural network layer, then the weight vector may represent a multi-dimensional weight tensor. In another example, if the neural network layer is a self-attention neural network layer, then the weight vector may represent weights of at least one of the query, key and/or value matrices. In another example, if the neural network layer is a convolution neural network layer, then the weight vector may represent a convolution kernel.

Each weight element is encoded as a bit string that includes a sign bit representing a sign value of the weight element and a set of exponent bits representing an exponent of a weight value. Each weight element may be encoded as a shift bit value in which the weight value is restricted to a power of two value or zero (if using regular float shift IPO); or each weight element may be encoded as a dense shift bit value in which the weight value is restricted to a non-zero power of two value (if using float dense shift IPO). The range of the power of two values may depend on the number of bits supported by the float shift IPO or float dense shift IPO.

Optionally, in some examples obtaining the weight vector may include converting a low-bit encoded weight vector (containing low-bit encoded weight elements) into a computing weight vector. The low-bit encoded weight vector may enable weight values to be stored using fewer memory resources, for example by requiring fewer bits to store each low-bit encoded weight element. The computing weight vector may be an expanded form of the low-bit encoded weight vector, in which the number of bits in the set of exponent bits in each weight element is equal to the number of bits in the set of exponent bits in each input element.

In some examples, the bit-length of each weight element may be equal to the bit-length of each floating point input element. In other examples, the bit-length of each weight element may be equal to only the bit-length of the sign bit plus exponent bits of the input element (e.g., as illustrated in FIG. 5B).

In some examples, the weight values may have been restricted to a power of two value or zero (if using regular float shift IPO) or restricted to a non-zero power of two value (if using float dense shift IPO) prior to the method 700. For example, QAT or other training techniques (e.g., as discussed in PCT/CN2022/077842) may be used to restrict the weight values to the supported power of two value (and/or zero if using regular float shift IPO).

Optionally, if the weight values are not already restricted to a power of two value or zero (if using regular float shift IPO) or restricted to a non-zero power of two value (if using float dense shift IPO), operations may be performed to convert each weight value to the appropriate power of two value (and/or zero if using regular float shift IPO) during the method 700. For example, operations may be performed to restrict the weight values to the power of two values (and/or zero if using regular float shift IPO) that is supported by the float shift IPO, by rounding the weight values during the method 700. Restricting the weight values in this manner may be performed prior to step 704 (e.g., at an initial step of the method 700), as part of step 704, or following step 704 but prior to step 706. For example, the processing unit 602 may include additional circuitry (not shown in FIG. 6) for rounding the weight value of each weight element in the weight vector to a power of two value (or zero if using regular float shift IPO).

At 706, the inner product between the floating point input vector and the weight vector is computed. Performing step 706 involves performing steps 708-710.

Step 708 is performed for each input element and a corresponding weight element (e.g., for the input element and weight element having the same index). For generality, step 708 will be described with respect to the k-th input element and the corresponding k-th weight element. Addition is performed to add the sign bit of the k-th weight element to the sign bit of the k-th input element, and to add the set of exponent bits of the k-th weight element to the set of exponent bits of the k-th input element. The result is the k-th weighted input element. This addition is performed for all input elements and corresponding weight elements.

Step 708 may be performed using an integer addition operator to perform each addition (e.g., as shown in FIG. 5A) or may be performed using a binary adder operator to perform each addition (e.g., as shown in FIG. 5B).

At 710, the weighted input elements obtained from performing step 708 for all input elements and corresponding weight elements are summed (e.g., using a floating point summation operator) to generate the inner product.

At 712, the inner product generated at step 710 is outputted as a floating point output element of the output vector of the neural network layer. In some examples, additional operations may be performed on the inner product before the inner product is outputted. For example, additional inner product operations may be performed, scaling operations may be performed, masking operations may be performed, etc.

The steps described above may be performed until all output elements of the output vector have been outputted. The output vector may be outputted to the next layer of the neural network or as the final output of the neural network (e.g., if the neural network layer that is computed using the method 700 is the final layer of the neural network).

The disclosed examples thus enable a neural network layer to be computed in a more efficient manner, for example by requiring lower power usage, fewer memory resources, lower computing power and/or smaller hardware footprint, compared to conventional computation of neural network layers. Further, the disclosed examples may avoid or reduce the need to perform quantization on the input values, which may help to improve accuracy and/or performance of the neural network. As such, examples of the present disclosure may help to enable computation (e.g., during training or inference) of a neural network in a computing system having more limited resources (e.g., in an edge computing system).

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system for computing an output of a neural network layer of a neural network, the computing system comprising:
a memory storing a weight vector for the neural network layer, each element of the weight vector being a weight element encoded as a bit string including a sign bit representing a sign value of the weight element and a set of exponent bits representing an exponent of a weight value; and
a processing unit coupled to the memory, the processing unit comprising:
circuitry configured to receive a floating point input vector to the neural network layer and the weight vector for the neural network layer, each element of the floating point input vector being a floating point input element encoded as a floating point bit string including a sign bit representing a sign value of the floating point input element and a set of exponent bits representing an exponent of the floating point input element;
circuitry configured to compute an inner product between the floating point input vector and the weight vector by:
for each floating point input element in the floating point input vector and a corresponding weight element in the weight vector, performing addition to add the sign bit of the weight element to the sign bit of the floating point input element and to add the set of exponent bits of the weight element to the set of exponent bits of the floating point input element, to generate a respective weighted input element; and
performing floating point summation of the respective weighted input elements to generate the inner product; and
circuitry configured to output the inner product as an output element of an output vector of the neural network layer.

2. The computing system of claim 1, wherein each weight element is encoded as a shift bit value including the sign value of the weight element and the weight value that is a power of two value or zero.

3. The computing system of claim 1, wherein each weight element is encoded as a dense shift bit value including the sign value of the weight element and the weight value that is a non-zero power of two value.

4. The computing system of claim 1, wherein the weight vector is stored as a low-bit encoded weight vector having low-bit encoded weight elements, each low-bit encoded weight element representing a corresponding weight element using fewer bits, and the low-bit encoded weight vector is converted to the weight vector.

5. The computing system of claim 1, wherein each weight element has a bit-length equal to a bit-length of the corresponding floating point input element.

6. The computing system of claim 1, wherein each weight element has a bit-length equal to a bit-length of the sign bit plus the set of exponent bits of the corresponding floating point input element.

7. The computing system of claim 1, wherein the circuitry configured to compute the inner product between the floating point input vector and the weight vector includes circuitry for an integer addition operator for performing the addition.

8. The computing system of claim 1, wherein the circuitry configured to compute the inner product between the floating point input vector and the weight vector includes circuitry for a binary addition operator for performing the addition.

9. The computing system of claim 1, wherein the neural network layer is a fully connected neural network layer, and wherein the weight vector represents a multi-dimensional weight tensor.

10. The computing system of claim 1, wherein the neural network layer is a self-attention neural network layer, and wherein the weight vector represents a weights of at least one of a query, key or value matrix.

11. The computing system of claim 1, wherein the neural network layer is a convolutional neural network layer, wherein the weight vector represents a convolutional kernel.

12. The computing system of claim 1, wherein the processing unit is a dedicated neural network accelerator.

13. The computing system of claim 1, wherein the processing unit further comprises:
circuitry configured to convert each weight element of the weight vector by rounding the weight value of each weight element to a power of two value;
wherein the weight vector of converted weight elements is used to compute the inner product.

14. A method for computing an output of a neural network layer of a neural network, the method comprising:
receiving a floating point input vector, each element of the floating point input vector being a floating point input element encoded as a floating point bit string including a sign bit representing a sign value of the floating point input element and a set of exponent bits representing an exponent of the floating point input element;
obtaining a weight vector for the neural network layer, each element of the weight vector being a weight element encoded as a bit string including a sign bit representing a sign value of the weight element and a set of exponent bits representing an exponent of a weight value;
computing an inner product between the floating point input vector and the weight vector by:
for each floating point input element in the floating point input vector and a corresponding weight element in the weight vector, performing addition to add the sign bit of the weight element to the sign bit of the floating point input element and to add the set of exponent bits of the weight element to the set of exponent bits of the floating point input element, to generate a respective weighted input element; and
performing floating point summation of the respective weighted input elements to generate the inner product; and
outputting the inner product as an output element of an output vector of the neural network layer.

15. The method of claim 14, wherein each weight element is encoded as a shift bit value including the sign value of the weight element and the weight value that is a power of two value or zero.

16. The method of claim 14, wherein each weight element is encoded as a dense shift bit value including the sign value of the weight element and the weight value that is a non-zero power of two value.

17. The method of claim 14, wherein obtaining the weight vector comprises converting a low-bit encoded weight vector having low-bit encoded weight elements, each low-bit encoded weight element representing a corresponding weight element using fewer bits, to the weight vector.

18. The method of claim 14, wherein each weight element has a bit-length equal to a bit-length of the corresponding floating point input element.

19. The method of claim 14, wherein each weight element has a bit-length equal to a bit-length of the sign bit plus the set of exponent bits of the corresponding floating point input element.

20. The method of claim 14, wherein performing the addition comprises performing an integer addition operation.
